(19) United States
(12) Patent Application Publication
(10) Pub. No.: US 2011/0096438 A1
(43) Pub. Date: Apr. 28, 2011

(54) HEAD-GIMBAL ASSEMBLY WITH TRACE CONFIGURED TO REDUCE STRESS ON A MICROACTUATOR AND DISK DRIVE INCLUDING THE HEAD-GIMBAL ASSEMBLY

(76) Inventors: Shigenori TAKADA, Kanagawa (JP); Haruhide Takahashi, Kanagawa (JP); Shinobu Hagiya, Kanagawa (JP); Kousaku Wakatsuki, Kanagawa (JP); Hiroyasu Tsuchida, Kanagawa (JP); Kimihiko Sudo, Kanagawa (JP)

(21) Appl. No.: 12/642,731

(22) Filed: Dec. 18, 2009

(30) Foreign Application Priority Data
Dec. 18, 2008 (JP) 2008-322246

(51) Int. Cl. G11B 5/48

(52) U.S. Cl. 360/244.2; 360/245.3; 360/246.4; G9B/5.147

(57) ABSTRACT

A head-gimbal assembly. The head-gimbal assembly includes a gimbal including a tongue, a stage forming a portion of the tongue, a head-slider bonded to the stage, first and second piezoelectric elements disposed on a rear side of the stage within an area of the tongue, and a trace formed on the gimbal. The first and second piezoelectric elements include respectively both a front connection pad and a rear connection pad, and are configured to extend and to contract in a fore-and-aft direction. The trace includes a plurality of leads for connecting a plurality of connection pads interconnected with a plurality of connection pads of the head-slider and configured for interconnection to connection pads of a preamplifier integrated circuit. The plurality of leads runs through and in between the front connection pad of the first piezoelectric element and the front connection pad of the second piezoelectric element.

### CROSS-REFERENCE TO RELATED APPLICATION

This application claims priority from the Japanese Patent Application No. 2008-322246, filed Dec. 18, 2008, the disclosure of which is incorporated herein in its entirety by reference.

### TECHNICAL FIELD

Embodiments of the present invention relate to a head-gimbal assembly (HGA) and a disk drive including the HGA.

### BACKGROUND

Disk drives are known in the art that use various kinds of disks, such as: optical disks, magneto-optical disks, flexible magnetic-recording disks, and similar disk data-storage devices. In particular, hard-disk drives (HDDs) have been widely used as indispensable data-storage devices for current computer systems. Moreover, HDDs have found widespread application to motion picture recording and reproducing apparatuses, car navigation systems, cellular phones, and similar devices, in addition to the computers, because of their outstanding information-storage characteristics.

A magnetic-recording disk used in an HDD has multiple concentric data tracks and servo tracks. Each data track includes a plurality of data sectors containing user data recorded in each data track. Each servo track has address information. A servo track includes a plurality of servo-data locations arranged discretely in the circumferential direction, and one or more data sectors are recorded between the servo data. A magnetic-recording head accesses a designated data sector in accordance with address information in the servo data to write data to, and read data from, the data sector.

The magnetic-recording head is formed on a slider; the slider is bonded to a suspension of an actuator. The assembly of the actuator and the head-slider is called a head stack assembly (HSA); and, the assembly of the suspension and the head-slider is called a HGA. The force associated with the pressure caused by air viscosity between an air-bearing surface (ABS) of the slider facing a magnetic-recording disk and a spinning magnetic-recording disk balances the load directed toward the magnetic-recording disk added by the suspension so that the head-slider flies in proximity with a recording surface of the magnetic-recording disk. The actuator pivots on a pivot shaft to move the head-slider to a target track and position the head-slider on the target track.

As the number of tracks per inch (TPI) of the magnetic-recording disk has increased with the advance of HDD technology, increased positioning accuracy of head-slider has been developed. However, the positioning accuracy in driving the actuator with a voice coil motor (VCM) is limited. As is known in the art, a technique of a two-stage actuator is employed that mounts a compact actuator, which is a microactuator, at a distal end of the actuator to provide finer positioning for the increased number of tracks per inch (TPI) of the magnetic-recording disk attending the advance of HDD technology.

Engineers and scientists engaged in HDD manufacturing and development are interested in the design of HDDs and HGAs used in HDDs that provide finer positioning control of the head-slider for writing data to, and reading data from, the magnetic-recording disk to meet the rising demands of the marketplace for increased data-storage capacity, performance, and reliability.

### SUMMARY

Embodiments of the present invention include a head-gimbal assembly. The head-gimbal assembly includes a gimbal including a tongue, a stage forming a portion of the tongue, a head-slider bonded to the stage, a first piezoelectric element disposed on a rear side of the stage within an area of the tongue, a second piezoelectric element disposed on the rear side of the stage within the area of the tongue, and a trace formed on the gimbal. The first piezoelectric element includes a front connection pad and a rear connection pad, and is configured to extend and to contract in a fore-and-aft direction. The second piezoelectric element includes a front connection pad and a rear connection pad, and is configured to extend and to contract in the fore-and-aft direction. The trace includes a plurality of leads for connecting a plurality of connection pads interconnected with a plurality of connection pads of the head-slider and configured for interconnection to connection pads of a preamplifier integrated circuit. The plurality of leads runs through and in between the front connection pad of the first piezoelectric element and the front connection pad of the second piezoelectric element.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is an example plan view depicting a hard-disk drive (HDD) with the cover for the disk enclosure (DE) of the HDD removed, in accordance with an embodiment of the present invention.

FIGS. 2(a) and 2(b) are an example perspective view depicting the structure of a head-gimbal assembly (HGA), and a partial enlarged view of a portion of the structure of the head-gimbal assembly (HGA) shown encircled by circle B in FIG. 2(a), respectively, in accordance with an embodiment of the present invention.

FIGS. 3(a) and 3(b) are example plan views depicting the structure of a head-slider, piezoelectric elements, and a vicinity of the structure of the head-slider and piezoelectric elements in the HGA, in accordance with an embodiment of the present invention.

FIG. 4 is an example cross-sectional view schematically depicting the stacked structure of the HGA, in accordance with an embodiment of the present invention.

FIGS. 5(a) and 5(b) are an example side view and a cross-sectional view depicting a portion of the HGA, respectively, in accordance with an embodiment of the present invention.

FIG. 6 is an example plan view further depicting the structure of the head-slider, piezoelectric elements, and the vicinity of the structure of the head-slider and piezoelectric elements in the HGA, in accordance with an embodiment of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### DESCRIPTION OF EMBODIMENTS OF THE PRESENT INVENTION FOR A HEAD-GIMBAL ASSEMBLY WITH A TRACE CONFIGURED TO REDUCE STRESS ON A MICROACTUATOR AND A DISK DRIVE INCLUDING THE HEAD-GIMBAL ASSEMBLY

As described above, with relevance to embodiments of the present invention, a microactuator provides fine positioning of a head-slider through minute movement of the microactuator. However, even if a microactuator is mounted on a suspension without change in the structure of a conventional suspension, the accuracy in head-slider positioning may not increase very much. This is due to degradation in characteristics of the suspension caused by the microactuator, itself.

One reason for the degradation is that the increase in mass and volume for the microactuator causes degradation in turbulence vibration characteristics of the suspension. Another reason is that the disk drive, which induces vibration, of the microactuator excites a number of vibrational modes in the suspension. In addition, the increase in mass for the microactuator causes degradation in impact resistant characteristics, or alternatively, loading/unloading capability, of the suspension.

A microactuator for improving these characteristics has a mechanism that rotates a head-slider using a piezoelectric element affixed on a gimbal tongue. In a head-gimbal assembly (HGA) including such a microactuator, a gimbal tongue has a stage on the trailing side of the gimbal tongue; and, a head-slider is bonded to the stage. Two piezoelectric elements are affixed on the gimbal tongue on the leading-edge side of the head-slider.

The two piezoelectric elements are arranged in line in the rotational direction of the actuator, and expand and contract in a fore-and-aft direction of the suspension, which is the flying direction of the head-slider. The left and right piezoelectric elements make opposite expansion and contraction motions to each other to rotate the stage, allowing the head-slider bonded to the stage to rotate together with the stage. The rotation of the head-slider imparts a slight motion to the magnetic-recording head in the radial direction of the magnetic-recording disk.

The two piezoelectric elements disposed within a gimbal tongue can suppress the above-described degradation in characteristics of the suspension. However, in accordance with embodiments of the present invention, the inventors have found through their research that the motion of the piezoelectric elements within the gimbal tongue is affected by the trace formed on the suspension. A trace includes a plurality of leads for transmitting signals for a head-slider and a resin layer for protecting the leads. In rotating a head-slider by expansion and contraction of the left and right piezoelectric elements, the stiffness of the trace disturbs the motion of the piezoelectric elements to reduce the amount of rotation of the head-slider relative to the amount of expansion and contraction of the piezoelectric elements.

Accordingly, embodiments of the present invention include a structure for an HGA that may reduce effects, which include the rotation of the head-slider, caused by the stiffness of the trace to the expansion and contraction of the two piezoelectric elements mounted on the gimbal tongue.

In accordance with embodiments of the present invention, a HGA includes: a gimbal including a tongue; a stage forming a portion of the tongue; a head-slider bonded to the stage; a first piezoelectric element disposed on the rear side of the stage within the area of the tongue, including a front connection pad and a rear connection pad, and configured to extend and to contract in a fore-and-aft direction; a second piezoelectric element disposed on the rear side of the stage within the area of the tongue, including a front connection pad and a rear connection pad, and configured to extend and to contract in a fore-and-aft direction, and a trace formed on the gimbal. In accordance with embodiments of the present invention, the trace includes a plurality of leads for connecting a plurality of connection pads interconnected with a plurality of connection pads of the head-slider and configured for interconnection to connection pads of a preamplifier integrated circuit (IC). In accordance with embodiments of the present invention, the plurality of leads runs through and in between the front connection pad of the first piezoelectric element and the front connection pad of the second piezoelectric element. Thus, in accordance with embodiments of the present invention, this arrangement provides suppression of an adverse effect of the trace on the rotation of the head-slider by expansion and contraction motion of the piezoelectric elements.

In one embodiment of the present invention, the plurality of leads runs under the head-slider. In another embodiment of the present invention, the plurality of leads runs around an adhesion area of the stage to the head-slider. Moreover, in another embodiment of the present invention, the plurality of leads run under the head-slider along a rear end of the adhesion area toward a central line extending in the fore-and-aft direction of the tongue. Thus, in accordance with embodiments of the present invention, these arrangements provide further suppression of an adverse effect of the trace on the rotation of the head-slider.

In another embodiment of the present invention, the plurality of leads runs in a vicinity of a center of rotation of the stage under the head-slider. Thus, in accordance with an embodiment of the present invention, this arrangement provides further suppression of an adverse effect of the trace on the rotation of the head-slider. In another embodiment of the present invention, the plurality of leads split into two groups between the first piezoelectric element and the second piezoelectric element; each group turns outward; one group runs on an outside of the rear connection pad of the first piezoelectric element and the other group runs on an outside of the rear connection pad of the second piezoelectric element; and, each group extends toward the connection pads configured for interconnection to the preamplifier IC. Thus, in accordance with an embodiment of the present invention, this arrangement provides suppression of an adverse effect of the trace on the motion of the gimbal.

In another embodiment of the present invention, the gimbal includes a body and two arms extending from the body frontward for supporting both sides of the tongue; and, the plurality of leads run between the two arms in a portion from the connection pads interconnected with the connection pads of the head-slider to the body. Thus, in accordance with an embodiment of the present invention, vibrations caused by the trace may be suppressed.

In another embodiment of the present invention, the gimbal includes a body and two arms extending from the body frontward for supporting both sides of the tongue. In another embodiment of the present invention, the tongue includes a support portion which is provided at the rear of the stage for supporting the stage and is connected to the arms. In another embodiment of the present invention, the trace connects the rear portion of the support portion and the body. Thus, in accordance with an embodiment of the present invention, this structure may suppress excessive deformation of the gimbal. In another embodiment of the present invention, the gimbal further includes a limiter for connecting the stage and each of the two arms, being made of the same material as an insulating layer of the trace. Thus, in accordance with an embodiment of the present invention, this structure may suppress excessive deformation of the gimbal while suppressing an increase in mass. In another embodiment of the present invention, the head-gimbal assembly further includes a load-beam for supporting the gimbal; and, fixing points where the gimbal is affixed to the load-beam are provided in front of and behind the tongue. Thus, in accordance with an embodiment of the present invention, this structure provides effective suppression of excessive deformation of the gimbal.

In accordance with other embodiments of the present invention, a disk drive includes: a disk enclosure (DE); a spindle motor affixed in the DE, for rotating a disk; and an actuator including a suspension for supporting a head-slider in proximity with a recording surface of a disk when the disk is rotated by the spindle motor, being pivoted by means of a voice coil motor. In accordance with embodiments of the present invention, the suspension includes a gimbal including a tongue; a stage which forms a portion of the tongue and to which a head-slider is bonded; a first piezoelectric element disposed on the rear side of the stage within the area of the tongue, including a front connection pad and a rear connection pad, and configured to extend and to contract in a fore-and-aft direction; a second piezoelectric element disposed on the rear side of the stage within the area of the tongue, including a front connection pad and a rear connection pad, and configured to extend and to contract in a fore-and-aft direction; and a trace formed on the gimbal. In accordance with embodiments of the present invention, the trace includes a plurality of leads for connecting a plurality of connection pads interconnected with a plurality of connection pads of the head-slider and connection pads for connecting to a preamplifier IC. In accordance with embodiments of the present invention, the plurality of leads run through and in between the front connection pad of the first piezoelectric element and the front connection pad of the second piezoelectric element. Thus, in accordance with embodiments of the present invention, this structure may increase the accuracy in positioning of the head-slider.

In a HGA with piezoelectric elements affixed on a gimbal tongue, embodiments of the present invention may suppress an adverse effect of a trace on rotation of a head-slider caused by expansion and contraction motions of the piezoelectric elements. In accordance with embodiments of the present invention, examples are described of a hard disk drive (HDD) as an example of a disk drive. In accordance with embodiments of the present invention, the HDD includes a two-stage actuator including a positioning mechanism using a voice coil motor and a positioning mechanism, which is a microactuator, using a piezoelectric element on a suspension. In accordance with embodiments of the present invention, the microactuator includes two piezoelectric elements affixed on a gimbal tongue. In accordance with embodiments of the present invention, the two piezoelectric elements are arranged side-by-side in the rotational direction, which is the left-and-right direction, of the actuator, and are configured to extend and to contract in the fore-and-aft direction of the suspension, which is the flying direction of the head-slider.

In accordance with yet other embodiments of the present invention, a gimbal tongue includes a stage on the trailing side of the gimbal tongue; and, a head-slider is bonded to the stage. In accordance with embodiments of the present invention, the left and right piezoelectric elements make opposite expansion and contraction motions to each other to cause the stage to rotate, so that the head-slider affixed on the stage rotates together with the stage. In accordance with embodiments of the present invention, rotation of the head-slider provides a minute movement of a magnetic-recording head in the radial direction of the magnetic-recording disk.

In accordance with embodiments of the present invention, leads for transmitting signals for the head-slider run from connection pads connected with the head-slider through and in between connection pads of two piezoelectric elements on the head-slider side. Thus, in accordance with embodiments of the present invention, this arrangement may reduce a stress caused by the trace stiffness against expansion and contraction of the piezoelectric elements to suppress decrease in stroke of the piezoelectric elements, and further, allows smooth expansion and contraction of the piezoelectric elements for rotating the head-slider. Thus, in accordance with embodiments of the present invention, the drive displacement of the slider may be increased to provide a highly precise head positioning.

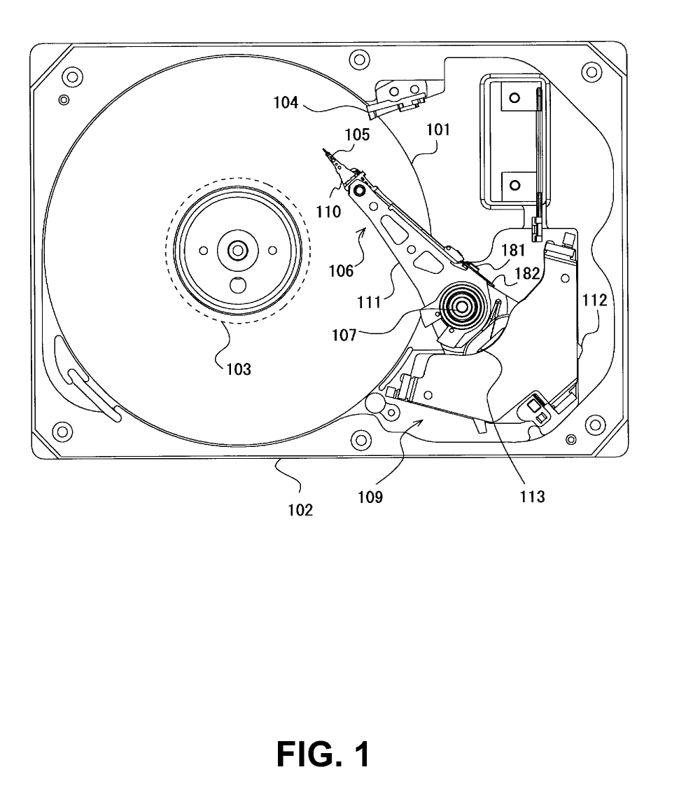

With reference now to FIG. 1, in accordance with an embodiment of the present invention, a plan view is shown that depicts a hard-disk drive (HDD) 1 with the cover for the disk enclosure (DE) of HDD 1 removed. Mechanical components for HDD 1 are housed in a base 102 of the DE; operation of the components in the base 102 of the DE is controlled by a control circuit (not shown) on a circuit board affixed outside the base. HDD 1 includes a magnetic-recording disk 101 as a disk for storing data, a head-slider 105 for accessing the magnetic-recording disk 101. As used herein, “access” is a term of art that refers to operations in seeking a data track of a magnetic-recording disk and positioning a magnetic-recording head on the data track for both reading data from, and writing data to, a magnetic-recording disk. The head-slider 105 includes a magnetic-recording head for writing user data to, and reading user data from, the magnetic-recording disk 101, and a slider on which the magnetic-recording head is provided.

An actuator 106 supports the head-slider 105. The actuator 106 pivots on a pivot shaft 107 to move the head-slider 105 in proximity with a recording surface of the spinning magnetic-recording disk 101 in order to access the magnetic-recording disk 101. A voice coil motor (VCM) 109, providing a driving mechanism, drives the actuator 106. The actuator 106 includes components of a suspension 110, an arm 111, a coil support 112, and a VCM coil 113 connected in this order from the distal end of the actuator 106 where the head-slider 105 is disposed in a longitudinal direction.

A spindle motor (SPM) 103 affixed in the base 102 of the DE spins the magnetic-recording disk 101 at a preset angular rate. The force exerted on the head-slider 105 by the pressure caused by air viscosity between an air-bearing surface (ABS) of the head-slider 105 facing the magnetic-recording disk 101 and the spinning magnetic-recording disk 101 balances the load applied by the suspension 110 on the head-slider 105 in the direction toward the magnetic-recording disk 101 so that the head-slider 105 flies in proximity with a recording surface of the magnetic-recording disk 101. In FIG. 1, the magnetic-recording disk rotates counterclockwise. Signals for the head-slider 105 and the piezoelectric elements of the microactuator are amplified by a preamplifier IC 181 provided near the pivot shaft for the actuator 106. The preamplifier IC 181 is implemented on a circuit board 182.

When the head-slider 105 is removed from proximity with the recording surface of the magnetic-recording disk 101, the actuator 106 stands by, above a ramp 104, which is provided outside the magnetic-recording disk 101. The moving operation of the actuator 106 from proximity with a recording surface of the magnetic-recording disk 101 toward the ramp 104 is called “unloading”; and, the moving operation of the actuator 106 from the ramp 104 into proximity with a recording surface of the magnetic-recording disk is called “loading”. The present invention is useful to an HDD employing a ramp loading and unloading scheme, but is also applicable to an HDD in which the actuator 106 moves to an inner area of the magnetic-recording disk 101 where a landing zone for the head-slider 105 may be provided.

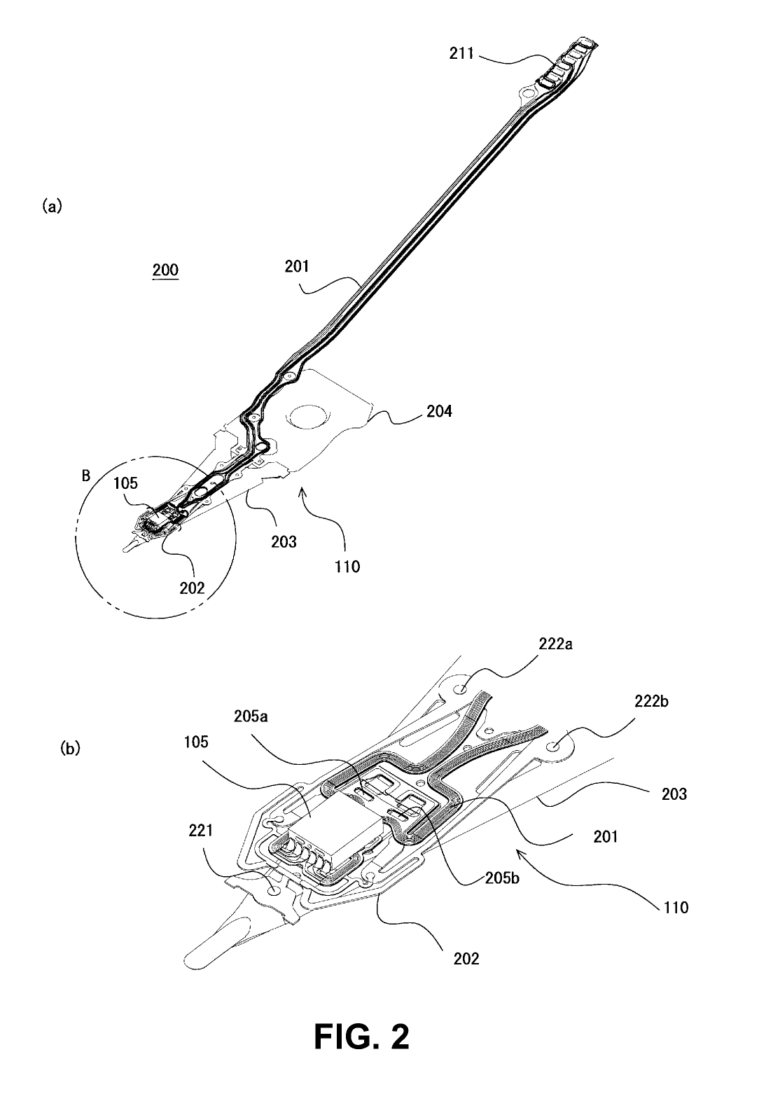

With reference now to FIGS. 2(a) and 2(b), in accordance with an embodiment of the present invention, in FIG. 2(a), a perspective view is shown that shows a configuration of an HGA 200, as viewed from the disk; and, in FIG. 2(b), an enlarged view is shown of the portion enclosed by the circle B in FIG. 2(a). As shown in FIG. 2(a), the HGA 200 includes a suspension 110 and a head-slider 105. The suspension 110 includes a trace 201, a gimbal 202, a load-beam 203, and a mounting plate 204.

The gimbal 202 is affixed to the load-beam 203 as a base; and further, the trace 201 is formed on the gimbal 202. The head-slider 105 is bonded to the surface of the gimbal 202 where the trace 201 is bonded. As shown in FIG. 2(b), the HGA 200 includes piezoelectric elements 205a and 205b which constitute a portion of the microactuator. The piezoelectric elements 205a and 205b are bonded to the backside of the surface of the suspension 110 where the head-slider 105 is bonded.

The load-beam 203 is made of stainless steel (SUS), for example, as a precision leaf spring. The stiffness of the load-beam 203 is higher than that of the gimbal 202. The spring properties of the load-beam 203 apply a load to the head-slider 105, when the head-slider 105 flies in proximity with a recording surface of the magnetic-recording disk 101. The mounting plate 204 and the gimbal 202 are also made of stainless steel, for example. The head-slider 105 is bonded to the gimbal 202. The gimbal 202 is supported elastically, holds the head-slider 105, and freely tilts to contribute to the positional control of the head-slider 105.

As shown in FIG. 2(b), in accordance with an embodiment of the present invention, in the HGA 200, the gimbal 202 is joined to the load-beam 203 at a point 221 in front of the head-slider 105 and at points 222a and 222b rearward of the head-slider 105. The joining is typically made by laser spot welding. Thus, in accordance with embodiments of the present invention, the gimbal 202 is joined with the load-beam 203 at both of front and rear points relative to the head-slider 105, providing the HGA 200 with a better loading/unloading property, which is referred to by the term of art, “peel property”.

Terminals at one end of the trace 201 including a plurality of leads are connected with the piezoelectric elements 205a and 205b and the head-slider 105; and terminals at the other end are incorporated in a multiconnector 211, which in turn is connected with a circuit board 182 to be affixed to the actuator 106. In the present configuration example, the multiconnector 211 has eight connection pads, which are for read signals, write signals, signals for a heater element for the purpose of clearance adjustment, and signals for the two piezoelectric elements 205a and 205b. The number of connection pads may change depending on the structure of the head-slider 105 and the control method of the piezoelectric elements 205a and 205b.

As shown in FIG. 1, on the circuit board 182, amplifier circuits in the preamplifier IC 181 for signals for the elements of the head-slider 105, for example, a read element and a write element of the head-slider 105, and for the piezoelectric elements 205a and 205b are implemented. The trace 201 transmits signals for controlling, in other words, for driving, the piezoelectric elements 205a and 205b, as well as a read signal and a write signal. As used herein, the direction connecting the end of the actuator 106, which includes the suspension 110, and the pivot shaft 107 is referred to as a “fore-and-aft direction”; and, the direction parallel to the main plane, which includes the recording surface, of the magnetic-recording disk 101 and perpendicular to the fore-and-aft direction, which is the rotational direction of the actuator 106, is referred to as a “left-and-right direction”.

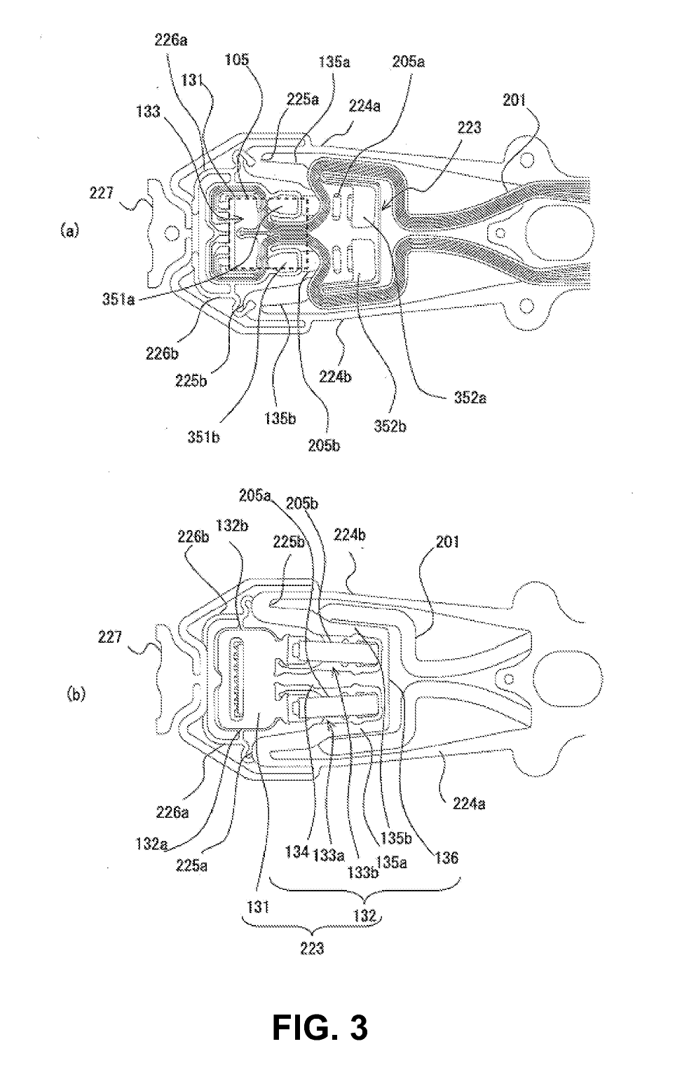

With reference now to FIGS. 3(a) and 3(b), in accordance with an embodiment of the present invention, plan views are shown that show the structure of the head-slider 105, the piezoelectric elements 205a and 205b, and the vicinity of the structure of the head-slider 105 and the piezoelectric elements 205a and 205b in the HGA 200. In FIGS. 3(a) and 3(b), the load-beam 203 is omitted for clarity of description. FIG. 3(a) is a drawing of the HGA 200 when viewed from the magnetic-recording disk side, which is the head-slider side of the HGA 200, and FIG. 3(b) is a drawing of the HGA 200 when viewed from the side opposite to the head-slider side of the HGA 200. In FIG. 3(a), the periphery of head-slider 105 is indicated by a dashed line; and, the head-slider 105 is drawn as though the head-slider 105 were transparent.

As described with reference to FIGS. 2(a) and 2(b), the trace 201 is disposed on the same side of the gimbal 202 as the head-slider 105. In FIG. 3(a), the trace 201 and the head-slider 105 are shown above the gimbal 202; and in FIG. 3(b), a gimbal 202 is shown above the trace 201. As shown in FIG. 3(b), the piezoelectric elements 205a and 205b are disposed on the opposite side of the trace 201 from the head-slider 105.

The gimbal 202 includes a gimbal tongue 223 at the middle, and side arms 224a and 224b which extend in the fore-and-aft direction from the gimbal tongue 223 on the left and right of the gimbal tongue 223, respectively. The gimbal tongue 223 is connected to the side arms 224a and 224b with the left and right connector tabs 225a and 225b, respectively.

The gimbal tongue 223 includes a stage 131 and a support portion 132 which is connected to the stage 131 at the rear, which is the leading side, of the stage 131 and supports the stage 131. The support portion 132 has two slits 133a and 133b extending in the fore-and-aft direction. The slits 133a and 133b are disposed in the left-and-right direction; and, the piezoelectric elements 205a and 205b are disposed inside the slits 133a and 133b, respectively. The piezoelectric elements 205a and 205b are configured to expand and contract in opposition to each other in the fore-and-aft direction to rotate the stage 131 and the head-slider 105 affixed on the stage 131.

The support portion 132 includes: a middle portion 134 between the slits 133a and 133b, a side portion 135a between the piezoelectric element 205a and the side arm 224a, and a side portion 135b between the piezoelectric element 205b and the side arm 224b. The middle portion 134 and the side portions 135a and 135b are joined at a rear portion 136, which is a base. The side portion 135a is connected to the side arm 224a by the connector tab 225a; and, the side portion 135b is connected to the side arm 224b by the connector tab 225b. The front end, which is the trailing end, of the middle portion 134 is connected to the rear end, which is leading end, of the stage 131.

On the stage 131, the head-slider 105 is disposed and affixed. In accordance with an embodiment of the present invention, the head-slider 105 is bonded to the stage 131 with adhesive applied to the stage 131. In FIG. 3(a), the head-slider 105 is bonded to an adhesion area 133 with adhesive. Thus, in accordance with an embodiment of the present invention, secure bonding of the head-slider 105 to the gimbal tongue 223 may be provided. To increase the peel stiffness of the HGA 200, the stage 131 is connected to the side arms 224a and 224b by polyimide limiters 226a and 226b. The polyimide limiters 226a and 226b may be formed simultaneously with the polyimide layer of the trace 201.

The side arms 224a and 224b are connected to the front of the stage 131. To the front ends of the side arms 224a and 224b, a support plate 227 is connected, and the support plate 227 is joined with the load-beam 203. The load-beam 203 having stiffness higher than the gimbal 202 supports the side arms 224a and 224b. In addition, the side arms 224a and 224b support the stage 131 and the head-slider 105, which is affixed on the stage 131, with the polyimide limiters 226a and 226b.

Thus, in accordance with embodiments of the present invention, the polyimide limiters 226a and 226b support the gimbal tongue 223 in front of the head-slider 105 so that excessive deformation of the gimbal tongue 223, which is a portion of the gimbal 202, in the pitch direction may be prevented. Such a limiter structure provides an alternative to a limiter, for example, a limiter made of stainless steel, within the gimbal, and provides reduction in turbulence vibrations, because of reduced mass of the polyimide limiters 226a and 226b in contrast with a limiter made of stainless steel. Moreover, since the limiters are provided across the head-slider, which is affixed on the stage 131, from the piezoelectric elements 205a and 205b, the flexural loading to the piezoelectric elements 205a and 205b may be reduced upon receiving an adventitious impact.

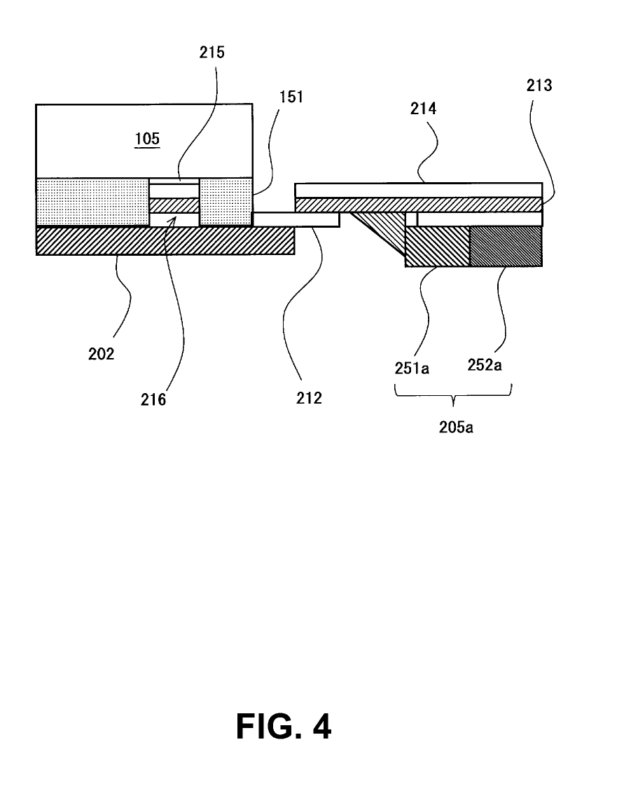

With further reference to FIG. 3(b) and reference now to FIG. 4, in accordance with embodiments of the present invention, in FIG. 3(b), the piezoelectric elements 205a and 205b are shown connected to the trace 201 on the opposite side of the side with the head-slider 105; and, in FIG. 4, a drawing is shown that schematically illustrates the stacked structure of the HGA 200. On the stainless steel layer of the gimbal 202, a polyimide underlayer 212 forming the trace 201, a conductive layer 213 on the polyimide underlayer 212, a polyimide first upper layer 214 on the conductive layer 213, and a polyimide second upper layer 215 on the polyimide first upper layer 214 are stacked. The manufacture of the suspension 110 forms a suitable shape by etching each layer in the above-described substrate having the above-described stacked structure.

The conductive layer 213 is typically a copper layer and constitutes leads for transmitting signals for the head-slider 105 and the piezoelectric elements 205a and 205b. The polyimide underlayer 212 is an insulating layer between the conductive layer 213 and the stainless steel layer of the gimbal 202; and, the polyimide first upper layer 214 is a protective layer for the conductive layer 213. The polyimide second upper layer 215 is a layer forming studs for supporting the head-slider 105, which is subsequently described.

In FIG. 4, the head-slider 105 is bonded to the top of the stainless steel layer 202 with adhesive 151. Specifically, the head-slider 105 is bonded with adhesive to the stainless steel layer 202 which is exposed by removing the polyimide second upper layer 215, the polyimide first upper layer 214, the conductive layer 213, and the polyimide underlayer 212. The exposed stainless steel layer 202 corresponds to the stage 131 in FIG. 3(a). On the stainless steel layer 202, three or more studs having the same structure as the stud 216 are formed. The head-slider 105 is disposed on the studs so that the position in height of the head-slider 105 is defined. Typically, studs are provided at two points on the stage 131 and at a point outside the stage 131.

The piezoelectric elements 205a and 205b are connected with the trace 201 on the opposite side of the side with the head-slider 105. FIG. 4 shows a connection pad 251a and a body 252a of the piezoelectric element 205a. The piezoelectric element 205a is affixed to the trace 201 exposed from the stainless steel layer 202. Specifically, the connection pad 251a is electrically and physically connected by solder joining with the conductive layer 213 exposed from the stainless steel layer 202 and the polyimide underlayer 212.

As shown in FIGS. 3(a) and 3(b), each of the piezoelectric elements 205a and 205b includes a front connection pad and a rear connection pad. The connection pads are solder-joined with connection pads 351a, 351b, 352a, and 352b of the conductive layer 213 exposed from the polyimide underlayer 212. So as not to disturb the expansion and contraction of the piezoelectric elements 205a and 205b, in one embodiment of the present invention, the piezoelectric elements 205a and 205b are not bonded to the polyimide underlayer 212, but are separated from the polyimide underlayer 212.

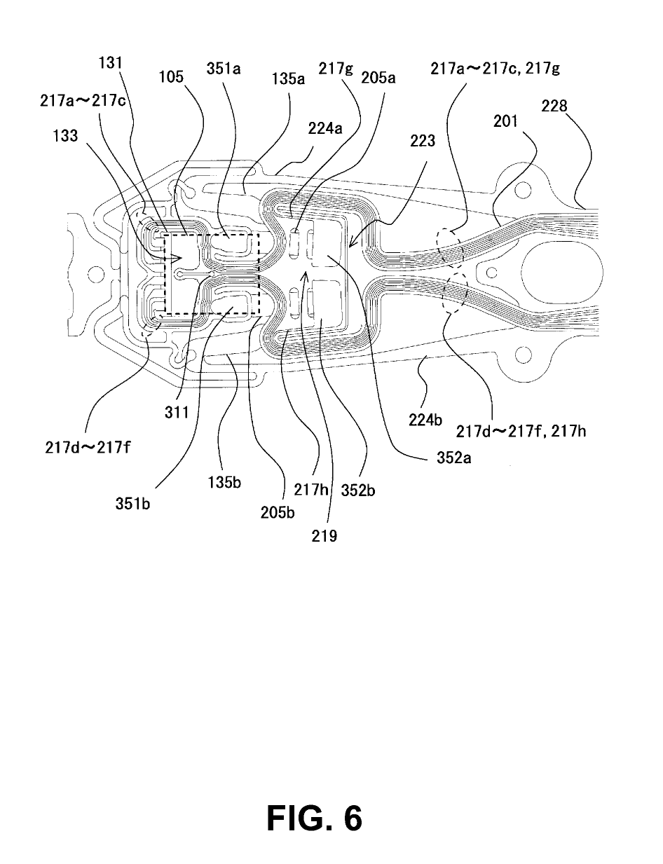

As shown in FIGS. 3(a) and 3(b), the stage 131 is connected to the piezoelectric elements 205a and 205b via the trace 201 and rotates on the rotational center 311 by the expansion and contraction of the piezoelectric elements 205a and 205b. The piezoelectric elements 205a and 205b make opposite expansion and contraction to each other, which increase the amount of rotation of the stage 131. In a structure in accordance with an embodiment of the present invention, the contact point of a dimple on the load-beam 203 to the gimbal 202 is the rotational center 311 (see FIG. 6) of the stage 131.

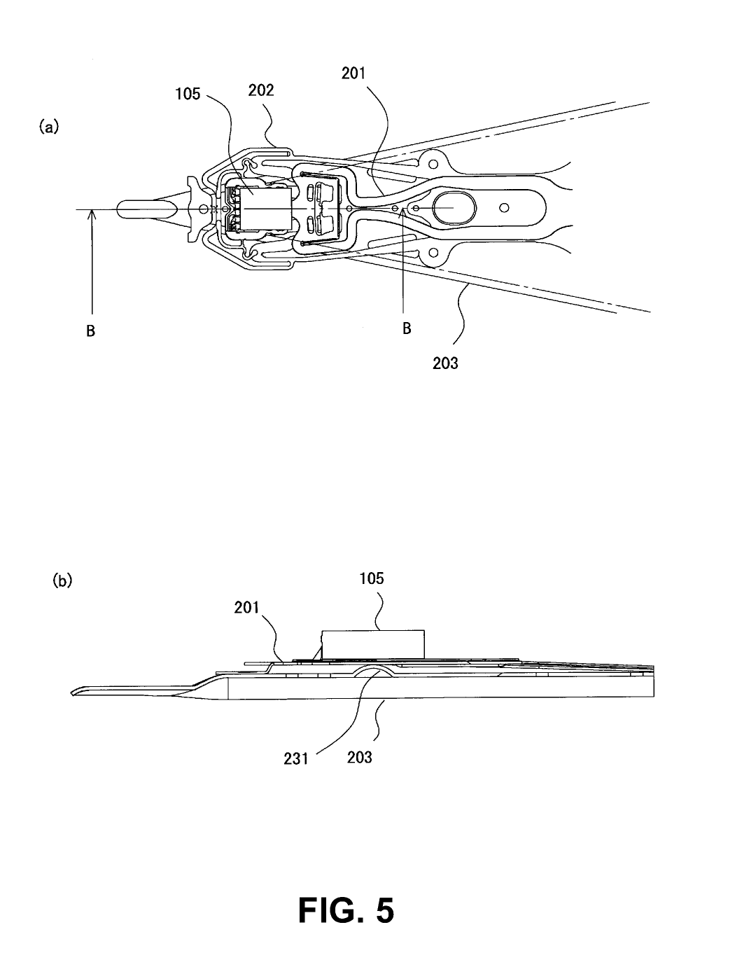

With reference now to FIGS. 5(a) and 5(b), in accordance with embodiments of the present invention, in FIG. 5(b), a cross-sectional view is shown for a cut along the B-B line in FIG. 5(a). The B-B section line is the center line extending in the longitudinal direction of the suspension 110. As shown in FIG. 5(b), the load-beam 203 has a dimple 231 protruding toward the gimbal 202. The dimple 231 has a curve; and, the top of the curve is in contact with the gimbal 202. As described above, the contact point of the dimple 231 and the rotational center of the stage 131 are the same; and, the rotational center is located at the end of the stage side of the middle portion 134 within the support portion 132 shown in FIG. 3. The dimple located at the center of rotation allows smoother rotation of the stage 131 and the head-slider 105 affixed on the stage 131.

With reference now to FIG. 6, in accordance with embodiments of the present invention, the same drawing as FIG. 3(a) is shown, but with additional elements labeled. As shown in FIG. 6, the head-slider 105 includes a plurality of connection pads arranged on the front end face, which is the trailing-edge side, in the left-and-right direction, which are connected with connection pads on the trace 201 formed on the stage 131. Typically, the connection pads arranged on the front end face are interconnected with connection pads on the trace 201 formed on the stage 131 by soldering. In the present structural example, six connection pads are provided and the six connection pads correspond to read signals, write signals, and signals, which provide electric power, for a heater element.

The trace 201 has six leads 217a to 217f which are disposed separately in a plane and connected with the above-described respective six connection pads. The leads 217a to 217f transmit signals to the corresponding connection pads of the head-slider 105 between the preamplifier IC 181 and the head-slider 105. In FIG. 6, the leads 217a to 217f of the head-slider 105, on the stage 131, run frontward from the connection pads; and then, a right half of the leads 217a to 217c are routed rightward; and, the remaining left half of the leads 217d to 217f are routed leftward.

The leads 217a to 217c run rearward through between the right edge 132a of the stage 131 (refer to FIG. 3(b)) and the adhesion area 133 for the head-slider 105, turn inward, and then get under the head-slider 105. The leads 217d to 217f run rearward through between the left edge 132b of the stage 131 (refer to FIG. 3(b)) and the adhesion area 133 for the head-slider 105, turn inward, and then get under the head-slider 105.

The leads 217a to 217f run between the head-slider 105 and the stainless steel layer 202, which is under the head-slider 105, along the rear end of the adhesion area 133 toward the middle of the gimbal tongue 223, which lies along the central line extending in the fore-and-aft direction. In the example of FIG. 3(a), the leads 217a to 217f run toward the center of rotation 311 of the head-slider 105, which is towards the stage 131, join together in the vicinity of the center of rotation 311, and run rearward.

Since the leads 217a to 127c run under the head-slider 105, the leads 217a to 217c may be gathered to the middle in the front as much as possible so that stress that might interfere with expansion and contraction of the piezoelectric elements 205a and 205b may be reduced. To attain a wider adhesion area 133, in one embodiment of the present invention, the center of rotation 311 may be located near the rear end of the adhesion area; but, the center of rotation 311 may also be located rearward from the location indicated in the drawing.

The leads 217a to 217c turning inward toward the center of rotation 311 run on the stage 131 through and in between the connection pad 351a of the trace 201 interconnected with the front connection pad of the piezoelectric element 205a and the adhesion area 133 toward the center of rotation 311. The leads 217d to 217f run on the stage 131 through and in between the connection pad 351b interconnected with the front connection pad of the piezoelectric element 205b and the adhesion area 133 toward the center of rotation 311.

In summary, the leads 217a to 217c run through and in between the front connection pad of the piezoelectric element 205a and the adhesion area 133, and the leads 217d to 217f run through and in between the front connection pad of the piezoelectric element 205b and the adhesion area 133. Thus, in accordance with embodiments of the present invention, the leads 217a to 217f gathering to the middle before the piezoelectric elements 205a and 205b may reduce stress that might interfere with expansion and contraction of the piezoelectric elements 205a and 205b. Moreover, the leads 217a to 217f running near the center of rotation 311 may reduce stress that might interfere with expansion and contraction of the piezoelectric elements 205a and 205b.

The leads 217a to 217f gathered in the vicinity of the center of rotation 311 run rearward through and in between the front connection pad of the piezoelectric element 205a (connection pad 351a of the trace) and the front connection pad of the piezoelectric element 205b (connection pad 351b of the trace). After passing between the front connection pad of the piezoelectric element 205a and the front connection pad of the piezoelectric element 205b, the leads 217a to 217f split leftward and rightward. The leads 217a to 217c in a bundle turn rightward, deviating from the gimbal tongue 223, which is associated with the support portion 132 (also refer to FIG. 3(b)). The leads 217d to 217f in a bundle turn leftward, deviating from the gimbal tongue 223, which is associated with the support portion 132 (also refer to FIG. 3(b)).

The leads 217a to 217c turn before the side arm 224a and run rearward along the inside of the side arm 224a. Moreover, a lead 217g for a connection pad 352a of the trace 201 interconnected with the rear connection pad of the piezoelectric element 205a joins the leads 217a to 217c. The leads 217d to 217f turn before the side arm 224b and run rearward along the inside of the side arm 224b. Moreover, a lead 217h for a connection pad 352b of the trace 201 interconnected with the rear connection pad of the piezoelectric element 205b joins the leads 217d to 217f.

The leads 217a to 217c and 217g extend rearward of the suspension 110 along the side arm 224a and pass between the rear connection pad of the piezoelectric element 205a (the connection pad 351a), and the side arm 224a. The leads 217a to 217c and 217g turn inward, run behind the rear connection pad of the piezoelectric element 205a (connection pad 351a), toward the middle of the suspension 110, which lies along the center line extending in the fore-and-aft direction.

Similarly, the leads 217d to 217f and 217h extend rearward of the suspension 110 along the side arm 224b and pass between the rear connection pad of the piezoelectric element 205b (the connection pad 351b), and the side arm 224b. Then, the leads 217d to 217f and 217h turn inward, run behind the rear connection pad of the piezoelectric element 205b (connection pad 351b), toward the middle of the suspension 110.

Then, the leads 217a to 217h turn rearward of the suspension 110, extend toward the rear portion of the suspension 110, and reach the body 228 of the gimbal 202 supporting the side arms 224a and 224b. As shown in FIG. 3(b), the leads 217a to 217h are not provided on the stainless steel layer between the position where the leads 217a to 217h deviate from the gimbal tongue 223 and the position where the leads 217a to 217h reach the gimbal body 228, but are suspended in the space, which provides a flying trace portion. Then, as shown in FIG. 2, the leads 217a to 217h run on the tail portion from the gimbal body 228 to the connection pads of the multiconnector 211.

Thus, in accordance with an embodiment of the present invention, the leads 217a to 217h extending outward between the front and rear connection pads of the piezoelectric elements 205a and 205b suppress increased stiffness of the gimbal 202, reducing degradation of the ability of the gimbal tongue 223 to follow a change in flying position of the head-slider 105.

In the trace 201, the conductive layer 213 is covered with the upper and lower polyimide layers 212 and 214 and is not exposed, except for the portion where the connection pads are formed. Accordingly, in the above description of routing of the leads 217a to 217h, the polyimide layers 212 and 214 are provided around the leads 217a to 217h. This is the same in the leads 217a to 217h formed on the stainless steel layer 202, as well as the flying trace portion.

In a arrangement in accordance with an embodiment of the present invention shown in FIG. 6, the leads 217a to 217h, which are included in the trace 201, are elongated between the two side arms 224a and 224b and do not depart from the area between the two side arms 224a and 224b in the portion from the connection pads of the head-slider 105 to the gimbal body 228. This arrangement suppresses turbulence vibrations of the gimbal 202 caused by vibrations of the trace 201, increases reliability by the support at the rear end of the gimbal tongue 223, and provides proper gimbal stiffness. Moreover, the trace 201 located in the vicinity of the center of the suspension reduces the inertial moment in the torsion direction of the suspension affecting the dynamic characteristics of the HGA.

As shown in FIG. 6, the trace 201 has a sheet portion 219 overlapping the leading side of the gimbal tongue 223, which is associated with the support portion 132. The leading end of the sheet portion 219 substantially corresponds to the leading end of the gimbal tongue 223. The sheet portion 219 includes sheet-like polyimide layers 212 and 214, a portion of the leads 217a to 217h, and connection pads 352a and 352b connected with the rear pads of the piezoelectric elements 205a and 205b.

The sheet portion 219 connects the middle portion 134 to constitute the support portion 132 of the gimbal tongue 223, the side portions 135a and 135b, and the rear portion 136 to reduce their vibration characteristics. In addition, the sheet portion 219 is affixed to the gimbal body 228 via the flying trace portion. Thus, in accordance with embodiments of the present invention, the trace 201 connects the rear, which is the leading side, of the gimbal tongue 223 and the gimbal body 228 to support the rear of the gimbal tongue 223. Thus, in accordance with an embodiment of the present invention, the trace 201 functions as a limiter for limiting excessive deformation of the gimbal 202 in loading/unloading.

As described with reference to FIG. 6, all of the leads 217a to 217f from the head-slider 105 extend through and in between the front pads of the piezoelectric elements 205a and 205b (the connection pads 351a and 351b of the trace), to the rear of the suspension 110. Thus, in accordance with an embodiment of the present invention, between the connection pads 351a and 351b connected with the front of the piezoelectric elements 205a and 205b and the connection pads of the head-slider 105, the leads 217a to 217f can be routed without the trace 201 spreading widely outward from the piezoelectric elements 205a and 205b.

In accordance with embodiments of the present invention, this arrangement can reduce stress from the trace 201 that might interfere with the expansion and contraction of the piezoelectric elements 205a and 205b, and can increase the amount of rotation of the head-slider 105 depending on the amount of expansion and contraction of the piezoelectric elements 205a and 205b. Furthermore, the smooth expansion and contraction motions of the piezoelectric elements 205a and 205b provides highly precise displacement control of the head-slider 105.

As described with reference to FIG. 6, in another embodiment of the present invention, the leads 217a to 217f run around the adhesion area 133 of the stage 131 and do not run through the adhesion area 133. The bonding of the head-slider 105 with adhesive can be more secure when the adhesive bonds the stainless steel layer 202 of the gimbal. Accordingly, the leads 217a to 217f running outside the adhesion area allow secure bonding of the head-slider 105 and a smaller adhesion area 133.

The leads 217a to 217f run through and in between the head-slider 105 and the stainless steel layer 202, which is on the back side of the ABS of the head-slider 105 to reach the area between the piezoelectric elements 205a and 205b. Thus, in accordance with an embodiment of the present invention, the arrangement of the leads 217a to 217h in the area of and at the middle of the head-slider 105 may reduce stress of the trace 201 that might interfere with expansion and contraction of the piezoelectric elements 205a and 205b. In particular, the leads 217a to 217f running near the center of rotation 311 of the head-slider 105 may enhance the effect.

In FIG. 6, the leads 217a to 217f are routed under the head-slider 105, or on the stage 131, in the area before, which is on the trailing side from, the rear end, which is the leading-edge side, of the head-slider 105. Accordingly, in the area before the rear end of the head-slider 105, there is no flying trace portion outside the head-slider 105. Thus, in accordance with embodiments of the present invention, this arrangement may reduce stress that reduces the stroke of the piezoelectric elements 205a and 205b, and may increase the drive displacement of the head-slider 105.

The leads 217a to 217f run through and in between the front connection pads of the piezoelectric elements 205a and 205b (the connection pads 351a and 351b of the trace), and then turn rightward and leftward, and run on the respective outsides of the rear pads (the connection pads 352a and 352b), as flying lines. Hence, the gimbal tongue 223 is supported by the trace 201 at their left and right sides. Thus, in accordance with embodiments of the present invention, this structure reduces the pitch stiffness of the gimbal tongue 223 to allow smooth following to a change in flying attitude of the head-slider 105.

As set forth above, embodiments of the present invention have been described by way of examples; but, embodiments of the present invention are not limited to the above-described examples, as embodiments of the present invention can, of course, be modified, added to, and/or elements of the examples converted in various ways within the spirit and scope of embodiments of the present invention. For example, embodiments of the present invention include disk drives with data-storage disks other than magnetic-recording disks used in HDDs, such as: optical disks, and magneto-optical disks, by way of example without limitation thereto. By way of further example, the present invention may be applied to an HDD which rotates a magnetic-recording disk clockwise when viewed from the top cover. In this case, in accordance with embodiments of the present invention, the front of the actuator is the leading side. In accordance with embodiments of the present invention, the location in the fore-and-aft direction of the interconnection portion between the front pads of the piezoelectric elements and the connection pads of the trace is not limited to the above-described location, but may be in front of the leading-edge side of the head-slider, or alternatively, be on the trailing side compared with the center of rotation of the head-slider.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A head-gimbal assembly, comprising:
a gimbal comprising a tongue;
a stage forming a portion of said tongue;
a head-slider bonded to said stage;
a first piezoelectric element disposed on a rear side of said stage within an area of said tongue, comprising a front connection pad and a rear connection pad, and configured to extend and to contract in a fore-and-aft direction;
a second piezoelectric element disposed on said rear side of said stage within said area of said tongue, comprising a front connection pad and a rear connection pad, and configured to extend and to contract in said fore-and-aft direction; and
a trace formed on said gimbal, comprising a plurality of leads for connecting a plurality of connection pads interconnected with a plurality of connection pads of said head-slider and configured for interconnection to connection pads of a preamplifier integrated circuit, said plurality of leads running through and in between said front connection pad of said first piezoelectric element and said front connection pad of said second piezoelectric element.

2. The head-gimbal assembly according to claim 1, wherein said plurality of leads run under said head-slider.

3. The head-gimbal assembly according to claim 1, wherein said plurality of leads run around an adhesion area on said stage for said head-slider.

4. The head-gimbal assembly according to claim 3, wherein said plurality of leads run under said head-slider along a rear end of said adhesion area toward a central line extending in said fore-and-aft direction of said tongue.

5. The head-gimbal assembly according to claim 1, wherein said plurality of leads run in a vicinity of a center of rotation of said stage under said head-slider.

6. The head-gimbal assembly according to claim 1, wherein said plurality of leads split into two groups between said first piezoelectric element and said second piezoelectric element; each group turns outward; one group runs on an outside of said rear connection pad of said first piezoelectric element and a other group runs on an outside of said rear connection pad of said second piezoelectric element; and each group extends toward said connection pads configured for interconnection to said preamplifier integrated circuit.

7. The head-gimbal assembly according to claim 1, wherein said gimbal further comprises a body and two arms extending from said body frontward for supporting both sides of said tongue; and, said plurality of leads run between said two arms in a portion from said connection pads interconnected with said connection pads of said head-slider to said body.

8. The head-gimbal assembly according to claim 1, wherein said gimbal comprises a body and two arms extending from said body frontward for supporting both sides of said tongue; said tongue comprises a support portion which is provided at said rear side of said stage for supporting said stage and is connected to said arms; and, said trace connects said rear portion of said support portion and said body.

9. The head-gimbal assembly according to claim 8, further comprising:
a limiter for connecting said stage and each of said two arms, being made of same material as an insulating layer of said trace.

10. The head-gimbal assembly according to claim 1, further comprising:
a load-beam for supporting said gimbal;
wherein fixing points where said gimbal is affixed to said load-beam are provided in front of and behind said tongue.

11. A disk drive comprising:
a disk enclosure;
a spindle motor affixed in said disk enclosure, for rotating a disk; and
an actuator comprising a suspension for supporting a head-slider in proximity with a recording surface of said disk when said disk is rotated by said spindle motor, said actuator configured for pivoting by means of a voice coil motor;
said suspension comprising:
a gimbal comprising a tongue;
a stage which forms a portion of said tongue and to which a head-slider is bonded;
a first piezoelectric element disposed on a rear side of said stage within an area of said tongue, comprising a front connection pad and a rear connection pad, and configured to extend and to contract in a fore-and-aft direction;
a second piezoelectric element disposed on said rear side of said stage within said area of said tongue, comprising a front connection pad and a rear connection pad, and configured to extend and to contract in said fore-and-aft direction; and
a trace formed on said gimbal, comprising a plurality of leads for connecting a plurality of connection pads interconnected with a plurality of connection pads of said head-slider and connection pads for connecting to a preamplifier integrated circuit, said plurality of leads running through and in between said front connection pad of said first piezoelectric element and said front connection pad of said second piezoelectric element.

12. The disk drive according to claim 11, wherein said plurality of leads run under said head-slider.

13. The disk drive according to claim 11, wherein said plurality of leads run around an adhesion area on said stage for said head-slider.

14. The disk drive according to claim 11, wherein said plurality of leads run in a vicinity of a center of rotation of said stage under said head-slider.

15. The disk drive according to claim 11, wherein said plurality of leads split into two groups between said first piezoelectric element and said second piezoelectric element; each group turns outward; one group runs on an outside of said rear connection pad of said first piezoelectric element and a other group runs on an outside of said rear connection pad of said second piezoelectric element; and each group extends toward said connection pads interconnected with said preamplifier integrated circuit.

16. The disk drive according to claim 11, wherein said gimbal further comprises a body and two arms extending from said body frontward for supporting both sides of said tongue; and, said plurality of leads run between said two arms in a portion from said connection pads interconnected with said connection pads of said head-slider to said body.

17. The disk drive according to claim 11, wherein said gimbal comprises a body and two arms extending from said body frontward for supporting both sides of said tongue; said tongue comprises a support portion which is provided at said rear side of said stage for supporting said stage and is connected to said arms; and, said trace connects a rear portion of said support portion and said body.
